(19) United States
(12) Patent Application Publication
(10) Pub. No.: US 2009/0151522 A1
(43) Pub. Date: Jun. 18, 2009

(54) Hand grip shell for pliers-type tools

(76) Inventors: Siegfried Storm, Schlangen (DE); Christian Heggemann, Detmold (DE); Detlev Hetland, Detmold (DE); Guenter Hanning, Detmold (DE); Thomas Koester, Schlangen (DE); Andreas Wedler, Detmold (DE)

Correspondence Address: LAUBSCHER & LAUBSCHER, P.C., 1160 SPA ROAD, SUITE 2B, ANNAPOLIS, MD, 21403, US

(21) Appl. No.: 12/290,557

(22) Filed: Oct. 31, 2008

(30) Foreign Application Priority Data
Nov. 2, 2007 (DE) 20 2007 015 350.3

(51) Int. Cl. B25B 7/00

(52) U.S. Cl. 81/427.5

(57) ABSTRACT

An accessory for pliers-type tools includes a shell that is removably connected with one or both levers of the tool to alter the size of the gripping portion of the tool to conform with the size of the user's hand. Each shell has a generally L-shaped configuration and an outer gripping surface which is arched, preferably in both longitudinal and latitudinal directions, to accommodate the user's hand. In addition, the levers include an opening adjacent to the gripping portion and the shells include a locking mechanism adapted to engage the lever within the opening to connect the shell with the lever.

### REFERENCE TO RELATED APPLICATIONS

This invention is related to the companion applications filed by the same inventors on the inventions entitled “Insulation Stripping Tool With Displaceable Knife Carrier Means”, Ser. No. ______ filed ______ (Docket No. 19919), and “Insulation Stripping Tool With Striker Means”, Ser. No. ______ filed ______ (Docket No. 19920).

### BACKGROUND OF THE INVENTION

Most hand tools and especially pliers and the like are provided in one size for ease and economy of manufacture. However, users of such tools have hands of different sizes. Thus, persons with larger or smaller hands relative to a standard hand size for which most tools are configured often have difficulty gripping and operating the tool. Moreover, workers who repeated use such tools as part of their job suffer from cramping and discomfort when trying to operate hand pliers which are not properly sized for the worker's hands.

### FIELD OF THE INVENTION

The invention relates to an accessory for pliers-type tools which is suitable for modifying the shape or configuration of the gripping portion of the pliers to accommodate the user's hand. More particularly, the invention is for use with electrical pliers used to strip insulation from wires and the like. Such pliers are generally formed from an insulating material, such as by injection molding or coated with an insulating material by dipping the pliers into a liquid insulator material, in order to protect the user from electrocution.

### DESCRIPTION OF RELATED ART

Insulated stripping pliers are well known in the prior art as evidenced by the German patent No. DE 29 705522 U1. While such pliers operate satisfactorily, they do not readily accommodate users having larger than normal hands. The present invention was developed in order to overcome these and other drawbacks of prior electrical stripping pliers by providing an accessory for the handle portion of the pliers which is economical to manufacture and which will alter the configuration of the handle portion to accommodate user's having larger hands.

### SUMMARY OF THE INVENTION

Accordingly, it is a primary object of the invention to provide a shell removably connected with the gripping portion of a lever of a pliers-type tool. The shell is configured to alter the contour of the lever gripping portion to match the size of the user's hand so that the user can comfortably grip and operate the tool. Separate shells may be provided for each lever.

The shell is designed to cover at least three sides of the lever, with an outer surface of the shell having an arched configuration to match the contour of the user's hand. In one embodiment, the shell fits over the lever in a snug-fit relation. In other embodiment, the shell is connected with the lever via a locking mechanism. More particularly, the lever includes an opening adjacent to the gripping portion thereof and the shell includes a detent which is retained within the opening.

### BRIEF DESCRIPTION OF THE DRAWINGS

Other objects and advantages of the invention will become apparent from a study of the following specification, when viewed in the light of the accompanying drawing, in which:

FIG. 1 is a perspective view of a pliers-type tool according to the invention; and

FIG. 2 is a perspective view of a pliers-type tool including an accessory shell according to the invention.

### DETAILED DESCRIPTION OF THE INVENTION

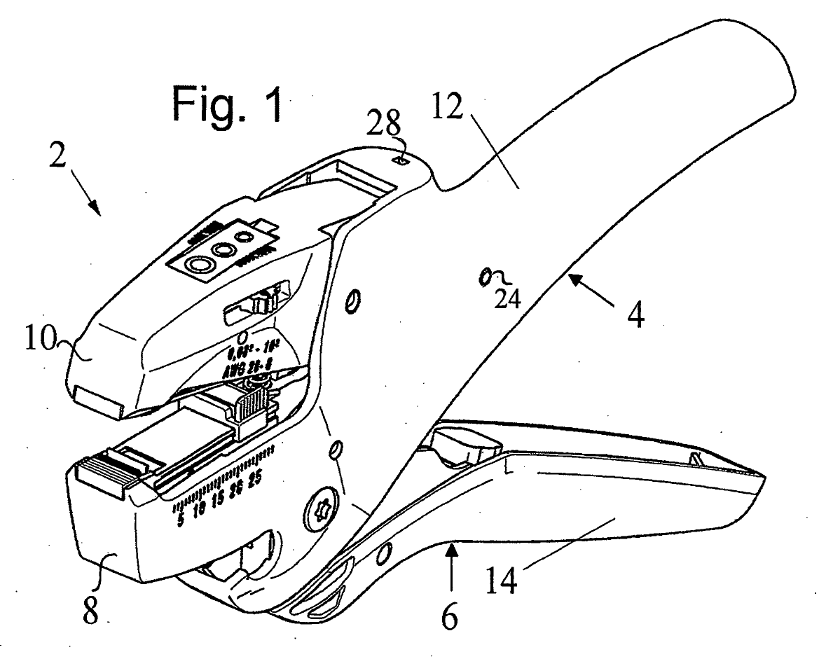

Referring to FIG. 1, there is shown a pliers-type tool 2 according to the invention. Preferably, the tool is a wire stripping tool used to remove insulation from electrical wire. The tool includes a pair of levers 4, 6 which are pivotally connected and include jaw portions 8, 10 and gripping portions 12, 14. The user grips the gripping portions and squeezes them together to bring the jaw portions together to clamp against a work piece such as the electrical wire.

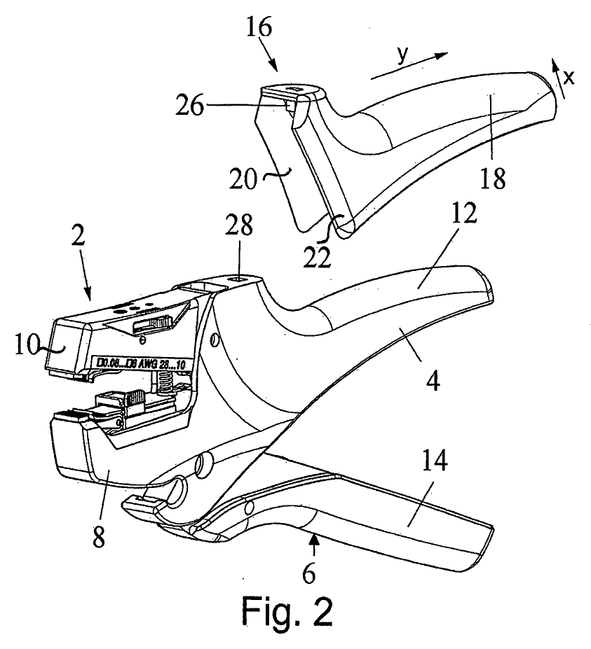

Typically, the pliers are formed of metal. However, because of the risk of electrocution, they are often coated with a layer of insulator material, either by dipping the levers into a liquid bath of heated insulator material prior to assembly of the tool or by placing the levers in a mold and injecting a layer of insulator material thereon. According to the invention, the insulator material is applied to one or more levers in the form of a shell as will be described with reference to FIG. 2.

As shown therein, a shell 16 is applied to the gripping portion 12 of the lever 4 of the tool 2. The shell is preferably formed of an insulating material such as synthetic plastic, rubber, or wood. The shell preferably has an L-shaped configuration and includes top 18 and side wall portions 20, 22 which define a cavity which is open at the front and bottom. In the embodiment shown, the shell 16 is adapted to fit over the lever 4 of the tool to alter the configuration of the gripping portion 12 of the lever to accommodate the hand size of the user. In one configuration, the shell side wall portions have limited flexure so that the shell may be snug fit or snapped onto the lever. In addition, the inner surface of the side walls may contain a recess (not shown) which receives a detent 24 provided on the outer surface of the lever as shown in FIG. 1 to hold the shell in place.

In a preferred embodiment, the shell 16 includes a locking tab 26 toward the front of the top wall 18 and between the side walls 20, 22. The tab is adapted to engage the lever 4 via an opening 28 in the top wall of the lever between the jaw 8 and gripping 12 portions to connect the shell with the lever. In order to remove the shell, the tab 26 is displaced to disengage the lever following which the shell can be removed.

The top wall 18 of the lever 4 has an outer surface with an arched configuration to conform to the hand of the user. Preferably, the surface is arched in both the latitudinal x and longitudinal y directions.

It will be appreciated that shells of different sizes and configurations may be provided to accommodate users of the tool with different sized hands. The shells are designed to be quickly removed from the lever and replaced with a different sized shell. While the shell has been illustrated and described for application to the lever 4, it will be readily apparent that similar shells may be designed for removable connection with the gripping portion 14 of the lever 6.

According to a further embodiment of the invention, the shell may be designed in the form of a hollow sleeve. That is, the shell may include a bottom wall in addition to top and side walls as in the sleeve of FIG. 2. With such a configuration, the sleeve is open at its forward end. The end portion of the lever is placed within the sleeve until the sleeve completely encapsulates the lever gripping portion. This insures that all metal portions of the lever gripping portion are covered by the sleeve to minimize the risk of electrocution should the lever gripping portion come into contact with a live wire.

By providing the properly sized sleeve on the gripping portion of the handle, fatigue from an improper fit of the tool within the user's hand is avoided. The sleeves may be economically produced and are designed for quick and easy replacement on the tool handle portion.

While in accordance with the provisions of the Patent Statutes the preferred forms and embodiments of the invention have been illustrated and described, it will be apparent to those skilled in the art that changes may be made without deviating from the invention described above.

What is claimed is:

1. An accessory for pliers-type tools comprising a pair of pivotally connected levers each having a portion for gripping by the hand of the user, comprising
(a) a shell removably connected with a gripping portion of at least one of the levers, said shell being configured to alter the contour of the at least one lever to match the size of the user's hand.

2. An accessory as defined in claim 1, wherein a shell is removably connected with the gripping portion of both of the levers, respectively.

3. An accessory as defined in claim 1, wherein the levers each include an opening adjacent the gripping portion and wherein said shell includes a locking mechanism adapted to engage said lever within the opening to connect said shell with the lever.

4. An accessory as defined in claim 1, wherein said shell has an L-shaped configuration.

5. An accessory as defined in claim 1, wherein said shell has an outer surface having an arched configuration in a first direction.

6. An accessory as defined in claim 5, wherein said shell has an outer portion having an arched configuration in a second direction normal to said first direction, whereby said outer portion is readily gripped by the user.

7. An accessory as defined in claim 1, wherein said shell is formed of one of synthetic plastic material, rubber material, or wood.
